(19) United States
(12) Patent Application Publication
(10) Pub. No.: US 2025/0314944 A1
(43) Pub. Date: Oct. 9, 2025

(54) OPTICAL MODULE AND CAMERA MODULE INCLUDING THE SAME

(71) Applicant: SAMSUNG ELECTRO-MECHANICS CO., LTD., Suwon-si (KR)

(72) Inventor: Hong Joo LEE, Suwon-si (KR)

(73) Assignee: SAMSUNG ELECTRO-MECHANICS CO., LTD., Suwon-si (KR)

(21) Appl. No.: 19/074,659

(22) Filed: Mar. 10, 2025

(30) Foreign Application Priority Data
Apr. 5, 2024 (KR) 10-2024-0046835
Jul. 15, 2024 (KR) 10-2024-0092981

(51) Int. Cl. G03B 5/00; G01D 5/14; G02B 7/182; G02B 27/64; G03B 30/00

(52) U.S. Cl. CPC G03B 5/00; G01D 5/145; G02B 7/1828; G02B 27/646; G03B 30/00; G03B 2205/0007; G03B 2205/0069

(57) ABSTRACT

An optical module is provided. The optical module includes a housing; a rotation holder disposed in the housing, and configured to rotate about a first rotational axis; a reflection holder on which an optical member is mounted, and supported by the rotation holder, and configured to rotate about a second rotational axis perpendicular to the first rotational axis; a rotational axis ball disposed between the housing and the rotation holder and forming the first rotational axis; a first sensing magnet disposed on the rotation holder in a position spaced apart from the rotational axis ball in a direction, perpendicular to both the first rotational axis and the second rotational axis; and a first position sensor disposed on the housing in a position spaced apart from the rotational axis ball in the direction perpendicular to both the first rotational axis and the second rotational axis.

### CROSS-REFERENCE TO RELATED APPLICATIONS

This application claims the benefit under 35 USC § 119(a) of Korean Patent Application No. 10-2024-0046835 filed on Apr. 5, 2024, and Korean Patent Application No. 10-2024-0092981 filed on Jul. 15, 2024, in the Korean Intellectual Property Office, the entire disclosures of which are incorporated herein by reference for all purposes.

### BACKGROUND

### 1. Field

The following description relates to an optical module and a camera module including the same.

### 2. Description of Related Art

Recently, most mobile devices, including smart-phones, are equipped with camera modules.

Camera modules implemented in mobile devices are manufactured to have operations such as, but not limited to, an autofocus operation and a shake correction operation despite their small size.

The autofocus operation and the shake correction operation are implemented by driving the optical elements, and in the camera module, an actuator provides a force to drive the optical elements.

Among various actuators, VCM actuators composed of permanent magnets and coils have advantages of being miniaturized and may achieve precise control, and are therefore commonly adopted in camera modules of many mobile devices.

However, due to spatial constraints of the mobile device, there is a problem, in that it may be difficult to increase the magnitude of the driving force and magnetic interference cannot be avoided, because the coil and position sensing element share a single permanent magnet.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an optical module includes a housing; a rotation holder disposed in the housing, and configured to rotate about a first rotational axis; a reflection holder on which an optical member is mounted, and supported by the rotation holder, and configured to rotate about a second rotational axis perpendicular to the first rotational axis; a rotational axis ball disposed between the housing and the rotation holder, and forming the first rotational axis; a first sensing magnet disposed on the rotation holder in a position spaced apart from the rotational axis ball in a direction perpendicular to both the first rotational axis and the second rotational axis; and a first position sensor disposed on the housing in a position spaced apart from the rotational axis ball in the direction perpendicular to both the first rotational axis and the second rotational axis.

The optical module may further include a first driving magnet disposed on the rotation holder; and a first driving coil disposed in the housing to face the first driving magnet, wherein the first driving magnet is magnetized such that a surface of the first driving magnet facing the first driving coil comprises a first polarity region of a first polarity and a second polarity region of a second polarity different from the first polarity.

The first sensing magnet may be magnetized such that a surface of the first sensing magnet facing the housing includes a first polarity region of a first polarity and a second polarity region of a second polarity different from the first polarity.

The first driving magnet may include two magnets, and wherein one magnet of the two magnets of the first driving magnet is disposed such that the first polarity region of the one magnet is adjacent to the first sensing magnet, and another magnet of the two magnets of the first driving magnet is disposed such that the second polarity region of the another magnet is adjacent to the first sensing magnet.

The first sensing magnet may be disposed such that the first polarity region of the first sensing magnet is adjacent to the magnet of the two magnets in which the first polarity region thereof is adjacent to the first sensing magnet, and the second polarity region of the first sensing magnet is adjacent to the magnet of the two magnets in which the second polarity region thereof is adjacent to the first sensing magnet.

The first position sensor may be disposed to face the first sensing magnet.

The first sensing magnet may be magnetized such that a surface of the first sensing magnet that faces the first position sensor includes a first polarity region and a second polarity region, wherein a neutral region may be provided between the first polarity region and the second polarity region, and wherein the first position sensor may be disposed to face the neutral region.

The first position sensor may be spaced apart from the first sensing magnet in the direction perpendicular to both the first rotational axis and the second rotational axis.

In a general aspect, an optical module includes a housing; a rotation holder disposed in the housing, and configured to rotate about a first rotational axis; a reflection holder on which an optical member is mounted, and supported on the rotation holder, and configured to rotate about a second rotational axis perpendicular to the first rotational axis; a plurality of first driving magnets disposed on the rotation holder; and a first sensing magnet disposed between the plurality of first driving magnets to have a gap in a second rotational axis direction.

The plurality of first driving magnets and the first sensing magnet may be magnetized such that a surface of the plurality of first driving magnets and a surface of the first sensing magnet, facing the housing, include a first polarity region of a first polarity and a second polarity region of a second polarity different from the first polarity.

The plurality of first driving magnets and the first sensing magnet may be disposed such that same polarity regions of the first driving magnets and the first sensing magnet may be adjacent to each other.

A plurality of first driving coils may be disposed in the housing to face each of the plurality of first driving magnets.

A first position sensor may be disposed in the housing to face the first sensing magnet.

The optical module may further include a first position sensor disposed in the housing to be spaced apart from the first sensing magnet in a direction perpendicular to both the first rotational axis and the second rotational axis.

The plurality of first driving magnets may be disposed obliquely each other such that a distance between first end portions of each of the plurality of first driving magnets adjacent to the first sensing magnet are closer to each other than a distance between second end portions of each of the plurality of second driving magnets disposed away from the first sensing magnet.

A camera module may include the optical module, and a lens module including one or more lenses disposed in an optical axis direction and configured to move in the optical axis direction.

In a general aspect, an optical module includes a housing; a rotation holder disposed in the housing, and configured to rotate about a first rotational axis; a reflection holder on which an optical member is mounted, and supported by the rotation holder, and configured to rotate about a second rotational axis perpendicular to the first rotational axis; a rotational axis ball disposed between the housing and the rotation holder, and forming the first rotational axis; a first sensing magnet disposed on the rotation holder in a position spaced apart from the rotational axis ball in a direction perpendicular to both the first rotational axis and the second rotational axis; and a driving magnet comprising a first driving magnet and a second driving magnet, wherein the first driving magnet, the second driving magnet, and the first sensing magnet are disposed in sequence along an axis perpendicular to the first rotational axis.

Other features and aspects will be apparent from the following detailed description, the drawings, and the claims.

### BRIEF DESCRIPTION OF DRAWINGS

FIG. 1 is a perspective view of an example camera module, in accordance with one or more embodiments.

FIG. 2 is a schematic exploded perspective view of an example camera module, in accordance with one or more embodiments.

FIG. 3 is a perspective view illustrating the arrangement relationship of a first lens module, a folded module, and a second lens module, in accordance with one or more embodiments.

FIG. 4 is a perspective view of an example first lens module, in accordance with one or more embodiments.

FIG. 5 is a perspective view of an example folded module, in accordance with one or more embodiments.

FIG. 6 is an exploded perspective view of an example folded module, in accordance with one or more embodiments.

FIG. 7 is an exploded perspective view of the folded module viewed from a different angle from that of FIG. 6.

FIG. 8 is a plan view illustrating a first driving portion and a first position sensing portion, in accordance with one or more embodiments.

FIG. 9, FIG. 10, and FIG. 11 are plan views illustrating a second driving portion and a second position sensing portion, in accordance with one or more embodiments.

FIG. 12 is an exploded perspective view of an example second lens module, in accordance with one or more embodiments.

FIG. 13 is a bottom perspective view of an example second lens module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

In the one or more examples, an X-direction, a Y-direction, and a Z-direction mean a direction parallel to an X-axis, a direction parallel to a Y-axis, and a direction parallel to a Z-axis, respectively, as illustrated in the drawings. Additionally, unless otherwise explained, the X-direction is a concept including both a +X-axis direction and a −X-axis direction, and the concept is also applied to a Y-direction and a Z-direction.

In the one or more examples, two directions (or axes) being parallel or perpendicular to each other also includes examples where the two directions (or axes) are substantially parallel or substantially perpendicular. For example, if a first axis and a second axis are mutually perpendicular means, the first axis and the second axis form an angle of 90 degrees or close to 90 degrees.

Hereinafter, one or more embodiments will be described in detail with reference to the attached drawings. However, the spirit of the one or more embodiments is not limited to the presented embodiments. For example, a person skilled in the art who understands the spirit of the one or more embodiments may suggest other embodiments included within the scope of the examples through the addition, change or deletion of components, etc., which will also be included within the scope of the present disclosure.

The one or more embodiments relate to an optical module and a camera module, and the camera module may be mounted on a portable electronic device such as, but not limited to, a mobile communication terminal, a smartphone, a tablet personal computer (PC), or the like.

An optical module may be a configuration including an optical member. In the one or more examples, the optical module may be understood to include one or more of a lens module, a folded module (reflective module), and an image sensor module. Additionally, the optical member may be understood to refer to one or more of a lens, a reflective element, and an image sensor.

One or more examples may provide a camera module with improved shake correction performance. Specifically, one or more examples may provide a camera module with increased driving force and reduced magnetic interference.

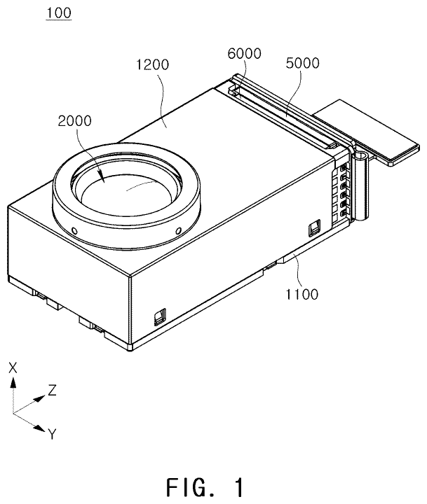

FIG. 1 is a perspective view of an example camera module 100, in accordance with one or more embodiments.

A camera module 100, in accordance with one or more embodiments, may have a length in a direction (Z-direction), perpendicular to a direction in which light is incident (X-direction).

The direction in which light is incident (X-direction) may be parallel to a thickness direction (X-direction) of the camera module 100. Additionally, the thickness direction (X-direction) of the camera module 100 may be parallel to the thickness direction of the mobile device in which the camera module 100 is adopted. That is, in accordance with one or more embodiments, even if a length of the camera module 100 increases, a thickness of the mobile device may not increase.

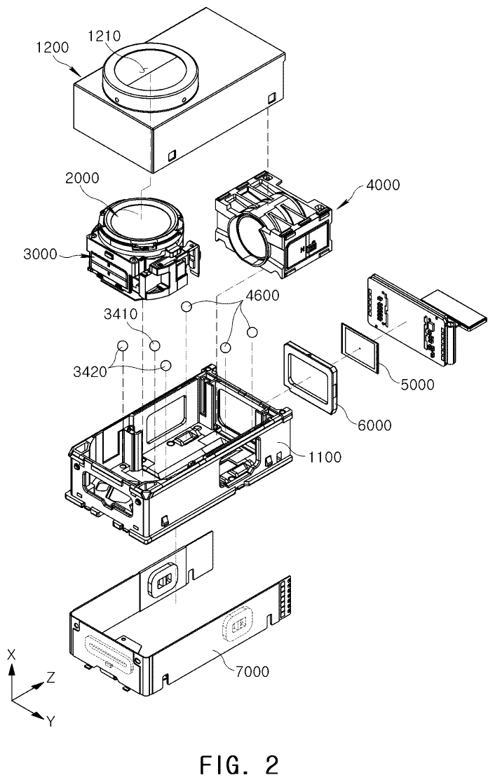

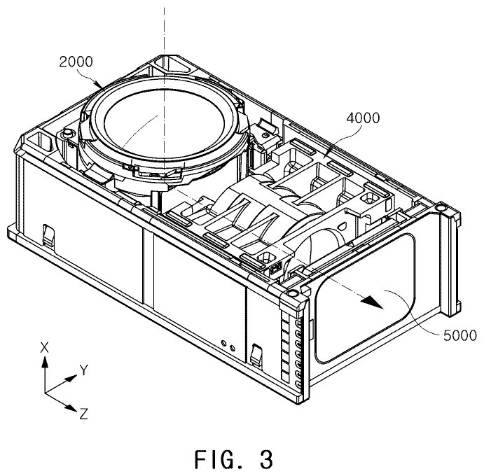

FIG. 2 is a schematic exploded perspective view of an example camera module 100, in accordance with one or more embodiments, and FIG. 3 is a perspective view illustrating an arrangement relationship of a first lens module 2000, a folded module 3000, and a second lens module 4000, in accordance with one or more embodiments.

A camera module 100, in accordance with one or more embodiments, may be configured to change the travelling path of light. For example, light incident in a camera module 100 may be changed in a direction (Z-direction) perpendicular to the incident direction (X-direction) inside the camera module 100.

Referring to FIG. 2, the camera module 100 may include a folded module 3000 that changes the travelling path of light incident on the camera module 100 by approximately 90 degrees.

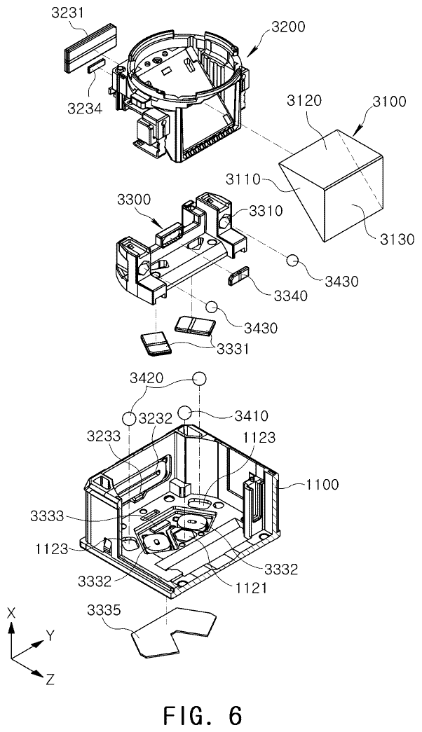

The folded module 3000 may be provided with a reflective member 3100 (FIG. 6) to change the traveling path of light.

Additionally, the camera module 100 may include a plurality of lens modules 2000 and 4000 including one or more lenses (L).

The plurality of lens modules 2000 and 4000 may include a first lens module 2000 disposed in front of the folded module 3000 based on the travelling path of light, and a second lens module 4000 disposed in the rear of the folded module 3000.

In an embodiment, an optical axis (X-axis) of the first lens module 2000 and an optical axis (Z-axis) of the second lens module 4000 may be different from each other. For example, the optical axis (X axis) of the first lens module 2000 and the optical axis (Z axis) of the second lens module 4000 may be perpendicular to each other.

In an embodiment, the camera module 100 may have an auto-focus operation and a shake correction operation. The autofocus operation may be implemented in a manner of driving the second lens module 4000, and the shake correction operation may be implemented in a manner of driving the first lens module 2000 and the folded module 3000.

The first lens module 2000, the folded module 3000, and the second lens module 4000 may be accommodated in the housing 1100 individually or together.

Referring to FIG. 2, the camera module 100 may include the housing 1100 that accommodates the first lens module 2000, the folded module 3000, and the second lens module 4000.

The housing 1100 may be a box-shaped member with an opened upper portion. The first lens module 2000, the folded module 3000, and the second lens module 4000 may be disposed in the housing 1100.

The camera module 100 may include an image sensor 5000 that converts light incident on the camera module 100 into an electrical signal.

In an example, the image sensor 5000 may be mounted on a printed circuit board and disposed in the housing 1100.

Light incident on the camera module 100 may pass through the first lens module 2000, the folded module 3000, and the second lens module 4000 in sequence, and may then be received by the image sensor 5000. The image sensor 5000 may generate an electrical signal corresponding to the light incident on the image sensor 5000.

A filter portion 6000 may be additionally disposed between the second lens module 4000 and the image sensor 5000.

The filter portion 6000 may perform an operation of blocking light in the infrared region among the light passing through the second lens module 4000 and incident on the image sensor 5000.

The camera module 100 may include a case 1200 that covers the opened upper portion of the housing 1100.

As the case 1200 is coupled to the housing 1100, the components disposed in the housing 1100 may be protected from the external environment.

In an example, the case 1200 may include an opening 1210 through which light is incident from the outside.

In an embodiment, the first lens module 2000 may be disposed in the opening 1210, and external light may be incident on the first lens module 2000.

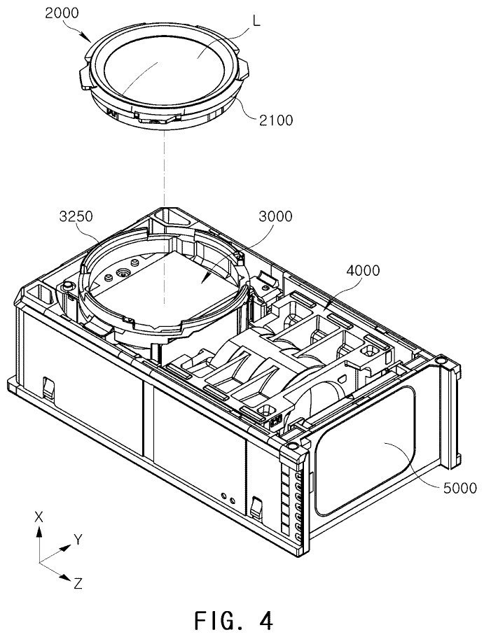

FIG. 4 is a perspective view of an example first lens module 2000, in accordance with one or more embodiments.

The first lens module 2000 may include a first lens barrel 2100.

One or more lenses (L) may be mounted on the first lens barrel 2100 in the first optical axis direction (X-axis direction).

The first lens barrel 2100 may be coupled to the folded module 3000 and may be driven integrally with the folded module 3000 during shake correction.

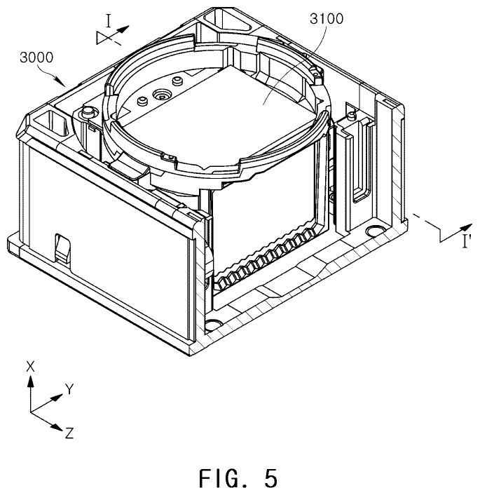

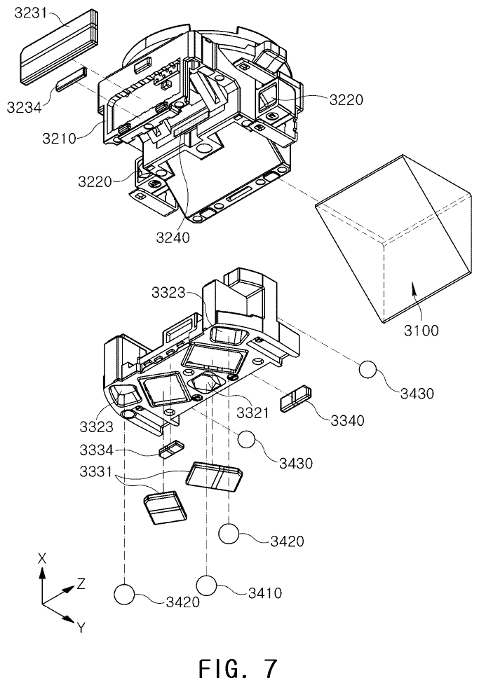

FIG. 5 is a perspective view of a folded module 3000, in accordance with one or more embodiments, FIG. 6 is an exploded perspective view of a folded module 3000, in accordance with one or more embodiments, and FIG. 7 is an exploded perspective view of the folded module 3000 viewed from a different angle from that of FIG. 6.

The folded module 3000 may include a reflective member 3100, a reflection holder 3200 to which the reflective member 3100 is coupled, and a rotation holder 3300 to which the reflection holder 3200 is supported.

In an example, the reflective member 3100 may be a mirror or a prism.

The reflective member 3100 may include a reflective surface 3110 that reflects light incident in the first optical axis direction (X-axis direction) to the second optical axis direction (Z-axis direction). The reflective surface 3110 may be disposed obliquely about the first optical axis direction (X-axis direction) and the second optical axis direction (Z-axis direction). If the reflective member 3100 is a prism, it may further include an incident surface 3120 and an exit surface 3130.

Although not illustrated in the drawing, at least one lens (hereinafter, correction lens) having positive refractive power may be coupled with the reflective member 3100.

In an example, the correction lens may be attached to the exit surface 3130 of the reflective member 3100, and may rotate together with the reflective member 3100. In this example, an error in the optical path occurring during shake correction may be compensated.

The reflective member 3100 and the first lens module 2000 may be coupled in the reflection holder 3200.

The first lens module 2000 and the reflective member 3100 may be provided in the first optical axis direction (X-axis direction), and the center of the lens (L) and the center of the reflective surface 3110 may be disposed on the first optical axis (X-axis)

The reflection holder 3200 may be supported to be rotated by the rotation holder 3300.

In an embodiment, the reflection holder 3200 may be rotated about the first rotational axis (Y-axis) relative to the rotation holder 3300. At this time, the reflective member 3100 and the first lens module 2000 may be rotated about the first rotational axis (Y-axis) together with the reflection holder 3200.

The folded module 3000 may include a driving portion (hereinafter, “first driving portion”) driving the reflection holder 3200.

The first driving portion may include a first driving magnet 3231 and a first driving coil 3232.

The first driving magnet 3231 may be disposed in the reflection holder 3200, and the first driving coil 3232 may be disposed in the housing 1100 through a main substrate 7000.

The first driving magnet 3231 and the first driving coil 3232 may be disposed to face each other in the second optical axis direction (Z-axis direction). The reflection holder 3200 may include an extended portion 3210 that extends to the rear of the rotation holder 3300 to face the housing 1100, and the first driving magnet 3231 may be disposed in the extended portion 3210.

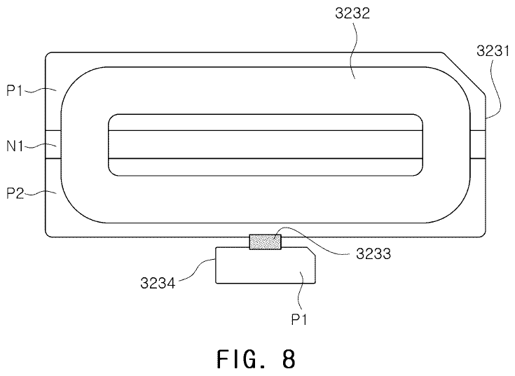

Referring to FIG. 8, the first driving magnet 3231 may be magnetized such that one surface facing the first driving coil 3232 may have both an N-pole and an S-pole. For example, the one surface of the first driving magnet 3231 may be provided with an N-pole (or a first polarity region) (P1), a neutral region (N1), and an S-pole (or a second polarity region) (P2) in the first optical axis direction (X-axis direction).

The first driving coil 3232 may be disposed in the housing 1100 to face the first driving magnet 3231 while being disposed on the main substrate 7000. The housing 1100 may include a through-hole, and the first driving coil 3232 may be disposed in the through-hole to directly face the first driving magnet 3231.

When power is applied to the first driving coil 3232, the first driving coil 3232 and the first driving magnet 3231 may generate a driving force in a direction, perpendicular to the direction in which they face each other, for example, in the first optical axis direction (X-axis direction), and the reflection holder 3200 may be rotated about the first rotational axis (Y-axis) by this driving force.

Since the first driving magnet 3231 is disposed in the reflection holder 3200, it may become a moving member that rotates together with the reflection holder 3200, and the first driving coil 3232 may become a fixed member that does not move.

A first ball member 3430, that supports rotation of the reflection holder 3200, may be disposed between the reflection holder 3200 and the rotation holder 3300.

The first ball member 3430 may form a first rotational axis (Y-axis). For example, the first ball member 3430 may include a plurality of balls that are spaced apart in the first rotational axis direction (Y-axis direction).

When viewed in the first rotational axis direction (Y-axis direction), a portion of the reflective member 3100 may overlap the first ball member 3430. For example, a virtual line connecting the first ball member 3430 in the first rotational axis direction (Y-axis direction) may overlap the reflective surface 3110.

The reflection holder 3200 and the rotation holder 3300 may respectively be provided with receiving grooves to receive different portions of the first ball member 3430. In an embodiment, the reflection holder 3200 may be provided with a first receiving groove 3220, and the rotation holder 3300 may be provided with a second receiving groove 3310 that faces the first receiving groove 3220.

The first ball member 3430 may form a rotational axis of the reflection holder 3200 while rotating in place, being accommodated in the first receiving groove 3220 and the second receiving groove 3310.

To prevent the detachment of the first ball member 3430, an attractive force may be applied between the reflection holder 3200 and the rotation holder 3300. For this, a first magnetic material 3240 and a second magnetic material 3340 may be disposed to face each other in the reflection holder 3200 and the rotation holder 3300, respectively.

In an embodiment, the first magnetic material 3240 disposed in the reflection holder 3200 may be a pulling yoke, and the second magnetic material 3340 disposed in the rotation holder 3300 may be a pulling magnet. However, in another embodiment, both the first magnetic material 3240 and the second magnetic material 3340 may be pulling magnets.

The first magnetic material 3240 and the second magnetic material 3340 may face each other in the second optical axis direction (Z-axis direction) and may generate an attractive force in the direction in which they face each other.

Due to the attractive force acting between the first magnetic material 3240 and the second magnetic material 3340, the reflection holder 3200 may be supported in the second optical axis direction (Z-axis direction) on the rotation holder 3300. Additionally, the first ball member 3430 may be maintained in contact with the reflection holder 3200 and the rotation holder 3300.

FIG. 8 is a plan view illustrating a first driving portion and a first position sensing portion, in accordance with one or more embodiments.

The folded module 3000 may include a position sensing portion (hereinafter, a first position sensing portion) that detects the position of the reflection holder 3200.

The first position sensing portion may include a first sensing magnet 3234 and a first position sensor 3233. In a non-limited example, the first position sensor 3233 may be a hall sensor.

The first sensing magnet 3234 may be disposed on the extended portion 3210 of the reflection holder 3200. For example, the first sensing magnet 3234 may be disposed in a position spaced apart from the first driving magnet 3231 in the first optical axis direction (X-axis direction).

The first position sensor 3233 may be disposed in the housing 1100 through the main substrate 7000. For example, the first position sensor 3233 may be disposed in a position spaced apart from the first driving coil 3232 in the first optical axis direction (X-axis direction).

The first sensing magnet 3234 may be magnetized such that one surface facing the first position sensor 3233 may have an N-pole or an S-pole.

In an embodiment, one surface of the first sensing magnet 3234 may have a polarity opposite to the polarity region of the first driving magnet 3231 adjacent to the first sensing magnet 3234.

In an example, when the first sensing magnet 3234 is disposed at a lower side of the first driving magnet 3231 based on a drawing, one surface of the first sensing magnet 3234 may have an N-pole (or a first polarity region) (P1). As another example, when the first sensing magnet 3234 is disposed at an upper side of the first driving magnet 3231 based on a drawing, one surface of the first sensing magnet 3234 may have an S-pole (or a second polarity region) (P2).

The camera module 100, in accordance with one or more embodiments, may sufficiently increase the size of the first coil 3232 facing the first driving magnet 3231 and increase the magnitude of the driving force by separately providing the first sensing magnet 3234 that senses the position of the reflection holder 3200.

The first position sensor 3233 may be disposed in a position to detect a change in the position of the first sensing magnet 3234.

In an embodiment, the first position sensor 3233 may be disposed to face a gap between the first driving magnet 3231 and the first sensing magnet 3234. In this example, the gap between the first driving magnet 3231 and the first sensing magnet 3234, may operate as a neutral region (N1).

When power is applied to the first driving coil 3232, the position of the reflection holder 3200, which is detected by the first position sensor 3233 based on the magnetic field generated from the first driving coil 3232, may differ from the actual position of the reflection holder 3200.

However, in accordance with one or more embodiments, the first position sensor 3233 may be spaced apart from the first driving coil 3232 such that it may be less affected by the magnetic field of the first driving coil 3232, such that the sensing accuracy of the first position sensor 3233 may be improved.

In an example, although not illustrated in the drawings, the first sensing magnet 3234 may be formed integrally with the first driving magnet 3231. In an example, the first driving magnet 3231 may further include a neutral region and an N-pole (or a first polarity region) or an S-pole (or a second polarity region) in the first optical axis direction (X-axis direction).

In this example, the first position sensor 3233 may be disposed to face the neutral region provided as the first driving magnet 3231 extends in the first optical axis direction (X-axis direction).

Referring again to FIG. 6, a rotation holder 3300 on which a reflection holder 3200 is supported may be supported to be rotatable on a housing 1100. In an embodiment, the rotation holder 3300 may be rotated with respect to the housing 1100 based on the second rotational axis (X-axis) and the first rotational axis (Y-axis), which are perpendicular to each other. In this example, the reflection holder 3200, the reflective member 3100 coupled to the reflection holder 3200 and the first lens module 2000 may be rotated about the second rotational axis (X-axis) together with the rotation holder 3300.

The folded module 3000 may include a driving portion (hereinafter, a second driving portion) that drives the rotation holder 3300.

The second driving portion may include a second driving magnet (3331: 3331a, 3331b) and a second driving coil (3332: 3332a, 3332b).

In a non-limited example, two each of the second driving magnet 3331 and the second driving coil 3332 may be provided. However, this is only an example, and the second driving magnet 3331 and the second driving coil 3332 may be provided in various numbers.

The second driving magnet 3331 may be disposed in the rotation holder 3300, and the second driving coil 3332 may be disposed in the housing 1100 through the main substrate 7000.

The second driving magnet 3331 and the second driving coil 3332 may be disposed to face each other in the first optical axis direction (X-axis direction).

The second driving magnet 3331 may be disposed on the bottom surface of the rotation holder 3300. In an embodiment, two magnets 3331a and 3331b configuring the second driving magnet 3331 may be disposed obliquely relative to each other. In an example, a first distance between a first end portion of the two magnets 3331a and 3331b may be closer than a second distance between a second end portion of the two magnets 3331a and 3331b.

The second driving coil 3332 may be disposed in the housing 1100 to face the second driving magnet 3331 while being disposed on the main substrate 7000. The housing 1100 may include a through-hole, and the second driving coil 3332 may be disposed in the through-hole to directly face the second driving magnet 3331. In this example, the second driving magnet 3331 and the second driving coil 3332 may face each other one-to-one.

The second driving magnet 3331 may be magnetized such that one surface that faces the second driving coil 3332 may have both an N-pole and an S-pole. In an example, the one surface of the second driving magnet 3331 may be provided with an N-pole (or a first polarity region) (P1), a neutral region (N1), and an S-pole (or a second polarity region) (P2) in a length direction of the magnet.

In an embodiment, one of the two magnets 3331a and 3331b configuring the second driving magnet 3331 may be provided with an N-pole (or a first polarity region) (P1), a neutral region (N1), and an S-pole (or a second polarity region) (P2) from one end portion to the other end portion in a length direction, and the other may be provided with an S-pole (or a second polarity region) (P2), a neutral region (N1), and an N-pole (or a first polarity region) (P1) from one end portion to the other end portion in a length direction.

When power is applied to the second driving coil 3332, the second driving coil 3332 and the second driving magnet 3331 may generate a driving force in a direction perpendicular to the direction in which they face each other, and the rotation holder 3300 may be rotated about the second rotational axis (X-axis) by this driving force.

Since the second driving magnet 3331 may be disposed in the rotation holder 3300, it may become a moving member that rotates together with the rotation holder 3300, and the second driving coil 3332 may become a fixed member that may not move.

A second ball member that supports a rotation of the rotation holder 3300 may be disposed between the rotation holder 3300 and the housing 1100.

The second ball member may include one rotational axis ball 3410 that forms the second rotational axis (X-axis). The second rotational axis (X-axis) may pass through the rotational axis ball 3410. Additionally, the second ball member may include a plurality of guide balls 3420 that are spaced apart from the rotational axis ball 3410.

The rotation holder 3300 and the housing 1100 may respectively be provided with receiving grooves to receive different portions of the rotational axis ball 3410. In an embodiment, the rotation holder 3300 may be provided with a third receiving groove 3321, and the housing 1100 may be provided with a fourth receiving groove 1121 facing the third receiving groove 3321.

The rotational axis ball 3410 may form a rotational axis of the rotation holder 3300 by rotating in place while being accommodated in the third receiving groove 3321 and the fourth receiving groove 1121.

Additionally, the rotation holder 3300 and the housing 1100 may respectively be provided with a plurality of guide grooves that accommodate different portions of a plurality of guide balls 3420. In an embodiment, the rotation holder 3300 may be provided with a first guide groove 3323, and the housing 1100 may be provided with a second guide groove 1123 facing the first guide groove 3323.

The first guide groove 3323 and the second guide groove 1123 may be straight or curved in shape with a length in a rotational direction of the rotation holder 3300.

A plurality of guide balls 3420 may support rotation of the rotation holder 3300 by rolling in the rotational direction of the rotation holder 3300 in the first guide groove 3323 and the second guide groove 1123.

To prevent the detachment of the second ball member, an attractive force may be applied between the rotation holder 3300 and the housing 1100. For this purpose, a third magnetic material 3335 may be disposed in the housing 1100 to face the second driving magnet 3331.

In an embodiment, the third magnetic material 3335 disposed in the housing 1100 may be a pulling yoke.

The third magnetic material 3335 may be disposed to cover an outer-side surface of the main substrate 7000. That is, the third magnetic material 3335 may face the second driving magnet 3331 with the second driving coil 3332 therebetween.

The second driving magnet 3331 and the third magnetic material 3335 may face each other in the first optical axis direction (X-axis direction) and may generate an attractive force in a direction in which they face each other.

Due to an attractive force acting between the second driving magnet 3331 and the third magnetic material 3335, the rotation holder 3300 may be supported in the first optical axis direction (X-axis direction) on the housing 1100. Additionally, the second ball member may maintain a state of contact with the rotation holder 3300 and the housing 1100.

Additionally, the third magnetic material 3335 may form a magnetic circuit with the second driving magnet 3331. The third magnetic material 3335 may focus the magnetic flux generated from the second driving magnet 3331.

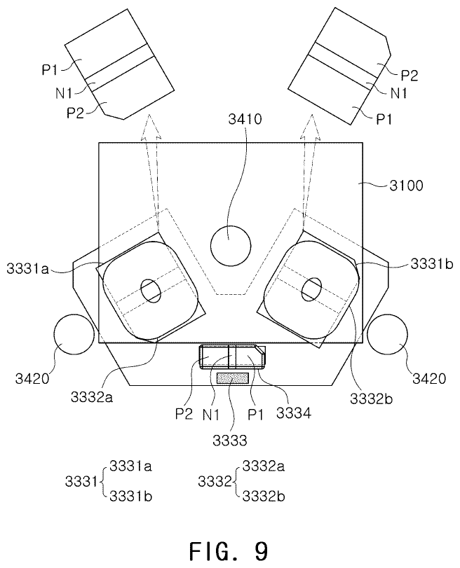

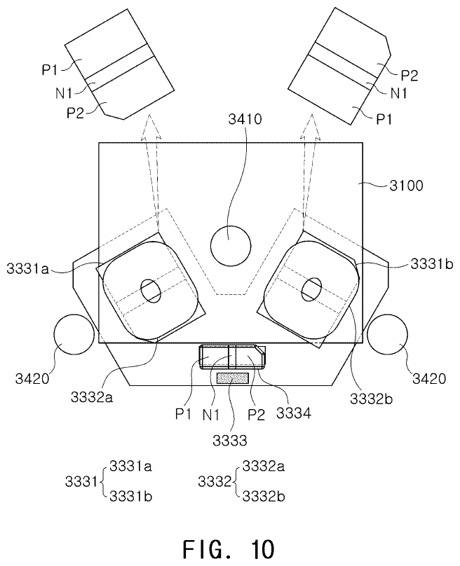

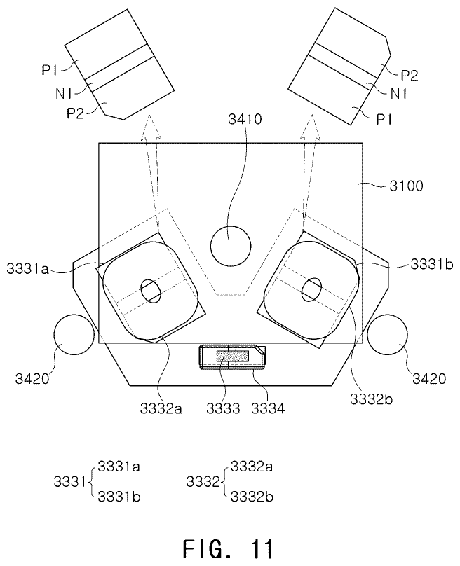

FIGS. 9 to 11 are plan views illustrating a second driving portion and a second position sensing portion, in accordance with one or more embodiments.

The folded module 3000 may include a position sensing portion (hereinafter, second position sensing portion) that detects the position of the rotation holder 3300.

The second position sensing portion may include a second sensing magnet 3334 and a second position sensor 3333. In an example, the second position sensor 3333 may be a hall sensor.

The second sensing magnet 3334 may be disposed in a position spaced apart from the rotational axis ball 3410 in the second optical axis direction (Z-axis direction) to the bottom surface of the rotation holder 3300. Accordingly, the second sensing magnet 3334 may be disposed approximately between two second driving magnets 3331a and 3331b.

The second position sensor 3333 may be disposed in the housing 1100 through the main substrate 7000. In an example, the second position sensor 3333 may be disposed in a position spaced apart from the rotational axis ball 3410 in the second optical axis direction (Z-axis direction). Accordingly, the second position sensor 3333 may be disposed approximately between two second driving coils 3332a and 3332b.

The second sensing magnet 3334 may be magnetized such that one surface that faces the second position sensor 3333 or the housing 1100 may have an N-pole and an S-pole. In an example, the one surface of the second sensing magnet 3334 may not necessarily have to face the second position sensor 3333.

In an embodiment, the one surface of the second sensing magnet 3334 may be provided with an N-pole (or a first polarity region) (P1), a neutral region (N1), and an S-pole (or a second polarity region) (P2) in a length direction of the magnet.

The neutral region (N1) of the second sensing magnet 3334 may be disposed in a position spaced apart from the rotational axis ball 3410 in the second optical axis direction (Z-axis direction).

In an embodiment, the second sensing magnet 3334 and the second driving magnet 3331 may be disposed such that each of adjacent polarity regions have the same polarity.

Referring to FIG. 9, the first polarity region (P1) of the second sensing magnet 3334 may be disposed adjacent to the first polarity region (P1) of driving magnet 3331b of the second driving magnet 3331, and the second polarity region (P2) of the second sensing magnet 3334 may be disposed adjacent to the second polarity region (P2) of driving magnet 3331a of the second driving magnet 3331.

In another embodiment, the second sensing magnet 3334 and the second driving magnet 3331 may be disposed such that adjacent polarity regions have opposite polarities.

Referring to FIG. 10, the first polarity region (P1) of the second sensing magnet 3334 may be disposed adjacent to the second polarity region (P2) of the driving magnet 3331a of the second driving magnet 3331, and the second polarity region (P2) of the second sensing magnet 3334 may be disposed adjacent to the first polarity region (P1) of the driving magnet 3331b of the second driving magnet 3331.

The camera module 100, in accordance with one or more embodiments, may increase the size and number of the second coil 3332 facing the second driving magnet 3331 by separately providing the second sensing magnet 3334 to sense the position of the rotation holder 3300, and since the second driving magnets 3331 provided in a plurality of pieces may be fully used to form driving force, the magnitude of the driving force may be increased.

The second position sensor 3333 may be disposed in a position to detect a change in a position of the second sensing magnet 3334.

The second position sensor 3333 may be disposed in a position spaced apart from the rotational axis ball 3410 in the second optical axis direction (Z-axis direction) in the housing 1100.

In an embodiment, the second position sensor 3333 may be disposed to face the neutral region (N1) of the second sensing magnet 3334. In another embodiment, the second position sensor 3333 may be spaced apart from the second sensing magnet 3334 in the second optical axis direction (Z-axis direction).

When power is applied to the second driving coil 3332, the position of the rotation holder 3300 detected by the second position sensor 3333 due to the magnetic field generated from the second driving coil 3332 may differ from the actual position of the rotation holder 3300.

However, in accordance with one or more embodiments, the second position sensor 3333 is spaced apart from the second driving coil 3332 such that it may be less affected by the magnetic field of the second driving coil 3332, therefore, the sensing accuracy of the second position sensor 3333 may be improved.

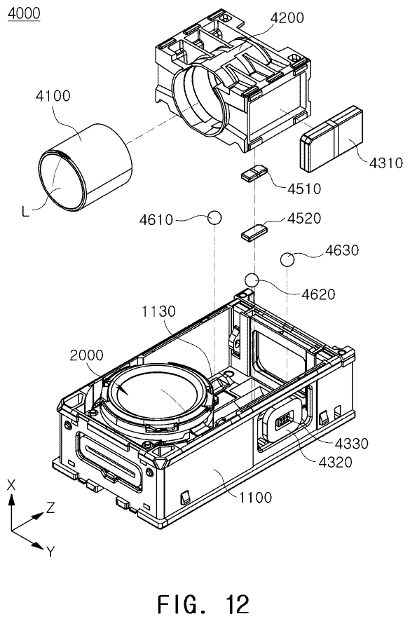

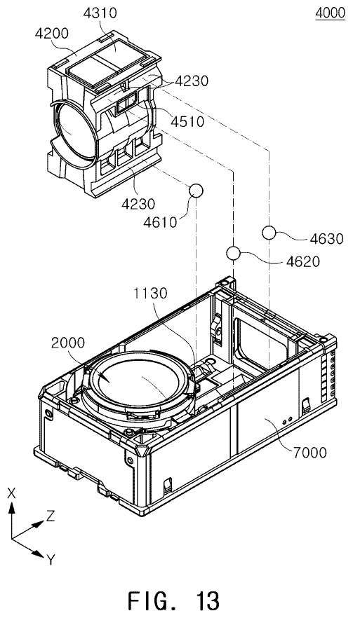

FIG. 12 is an exploded perspective view of a second lens module 4000, in accordance with one or more embodiments, and FIG. 13 is an exploded perspective diagram of a second lens module 4000, in accordance with one or more embodiments, viewed from below.

The second lens module 4000 may be disposed between the folded module 3000 and the image sensor 5000.

The second lens module 4000 may include a second lens barrel 4100.

A plurality of lenses (L) may be mounted on the second lens barrel 4100 in the second optical axis direction (Z-axis direction).

The second lens barrel 4100 may be coupled to a lens carrier 4200.

The lens carrier 4200 may be supported to be movable on the housing 1100.

In an embodiment, the lens carrier 4200 may be moved in the second optical axis direction (Z-axis direction) relative to the housing (1100). In this example, the second lens barrel 4100 may be moved in the second optical axis direction (Z-axis direction) together with the lens carrier 4200.

The second lens module 4000 may include a driving portion (hereinafter, third driving portion) that drives the lens carrier 4200.

The third driving portion may include a third driving magnet 4310 and a third driving coil 4320.

The third driving magnet 4310 may be disposed in the lens carrier 4200, and the third driving coil 4320 may be disposed in the housing 1100 through the main substrate 7000.

The third driving magnet 4310 and the third driving coil 4320 may be disposed to face each other in a direction (Y-axis direction) perpendicular to both the first optical axis (X-axis) and the second optical axis (Z-axis).

The third driving magnet 4310 may be disposed on one or both side-surfaces of the lens carrier 4200.

The third driving coil 4320 may be disposed in the housing 1100 to face the third driving magnet 4310 while being disposed on the main substrate 7000. The housing 1100 may include a through-hole, and the third driving coil 4320 may be disposed in the through-hole to directly face the third driving magnet 4310.

The third driving magnet 4310 may be magnetized such that one surface facing the third driving coil 4320 may have both an N-pole and an S-pole. For example, the one surface of the third driving magnet 4310 may be provided with an N-pole (or a first polarity region), a neutral region, and an S-pole (or a second polarity region) in the second optical axis direction (Z-axis direction).

When power is applied to the third driving coil 4320, the third driving coil 4320 and the third driving magnet (4310) may generate a driving force in a direction perpendicular to the direction in which they face each other, for example, a driving force may be generated in the second optical axis direction (Z-axis direction), and the lens carrier (4200) may be moved in the second optical axis direction (Z-axis direction) by this driving force.

Since the third driving magnet 4310 may be disposed in the lens carrier 4200, it may become a moving member that moves together with the lens carrier 4200, and the third driving coil 4320 may become a fixed member that does not move.

A third ball member supporting movement of the lens carrier 4200 may be disposed between the carrier 4200 and the housing 1100.

The third ball member may include three or more guide balls 4610, 4620 and 4630. In an embodiment, the third ball member may include three guide balls 4610, 4620 and 4630.

The three guide balls 4610, 4620 and 4630 may be disposed separately on one side and the other side of the lens carrier 4200. For example, among the three guide balls 4610, 4620 and 4630, two guide balls 4620 and 4630 may support one side of the lens carrier 4200 (preferably, a portion closer to the third driving portion) and the one guide ball 4610 may support the other side of the lens carrier 4200. One side and the other side of the lens carrier 4200 may be disposed opposite each other about the second optical axis (Z axis).

Two guide balls 4620 and 4630 disposed on one side of the lens carrier 4200 may be spaced apart in the second optical axis direction (Z-axis direction).

The lens carrier 4200 and housing 1100 may respectively be provided with a plurality of guide grooves that accommodate different portions of three guide balls 4610, 4620 and 4630. In an embodiment, the lens carrier 4200 may be provided with a third guide groove 4230, and the housing 1100 may be provided with a fourth guide groove 1130 that faces the third guide groove 4230.

The third guide groove 4230 and the fourth guide groove 1130 may be straight lines having a length in the direction of movement of the lens carrier 4200, i.e., in the second optical axis direction (Z-axis direction).

A plurality of guide balls 4610, 4620 and 4630 may support the movement of the lens carrier 4200 by rolling in the movement direction of the lens carrier 4200 in the third guide groove 4230 and the fourth guide groove 1130.

In an embodiment, the number of contact points of at least one of the two guide balls 4620 and 4630 supporting one side of the lens carrier 4200 with the guide groove, may be greater than the number of contact points of the remaining guide ball 4610 with the guide groove. In an example, at least one of the two guide balls 4620 and 4630 supporting one side of the lens carrier 4200 may be in two-point contact with the third guide groove 4230 and/or the fourth guide groove 1130. In this example, a cross-sectional surface of the third guide groove 4230 and/or the fourth guide groove 1130 may be ‘v’ shaped.

To prevent the detachment of the third ball member, an attractive force may be applied between the lens carrier 4200 and the housing 1100. For this purpose, a fourth magnetic material 4510 and a fifth magnetic material 4520 may be disposed facing each other in the lens carrier 4200 and the housing 1100, respectively.

In an embodiment, the fourth magnetic material 4510 disposed in the lens carrier 4200 may be a pulling magnet, and the fifth magnetic material 4520 disposed in the housing 1100 may be a pulling yoke. However, in another embodiments, both the fourth magnetic material 4510 and the fifth magnetic material 4520 may be pulling magnets.

The fourth magnetic material 4510 and the fifth magnetic material 4520 may face each other in the first optical axis direction (X-axis direction) and may generate an attractive force in a direction in which they face each other.

Due to an attractive force acting between the fourth magnetic material 4510 and the fifth magnetic material 4520, the lens carrier 4200 may be supported in the housing 1100 in the first optical axis direction (X-axis direction). Additionally, the third ball member may remain in contact with the lens carrier 4200 and the housing 1100.

In an embodiment, it may be desirable for the fourth magnetic material 4510 to be disposed closer to one side of the lens carrier 4200 than the other side of the lens carrier 4200.

The second lens module 4000 may include a third position sensor 4330 that detects the position of the lens carrier 4200. In an example, the third position sensor 4330 may be a hall sensor.

The third position sensor 4330 may be disposed in the housing 1100 through the main substrate 7000. In an example, the third position sensor 4330 may be disposed inside or outside of the third driving coil 4320.

The third position sensor 4330 may be disposed to face the neutral region of the third driving magnet 4310.

One or more embodiments may increase the driving force and reduce magnetic interference.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An optical module, comprising:
a housing;
a rotation holder disposed in the housing, and configured to rotate about a first rotational axis;
a reflection holder on which an optical member is mounted, and supported by the rotation holder, and configured to rotate about a second rotational axis perpendicular to the first rotational axis;
a rotational axis ball disposed between the housing and the rotation holder, and forming the first rotational axis;
a first sensing magnet disposed on the rotation holder in a position spaced apart from the rotational axis ball in a direction perpendicular to both the first rotational axis and the second rotational axis; and
a first position sensor disposed on the housing in a position spaced apart from the rotational axis ball in the direction perpendicular to both the first rotational axis and the second rotational axis.

2. The optical module of claim 1, further comprising:
a first driving magnet disposed on the rotation holder; and
a first driving coil disposed in the housing to face the first driving magnet,
wherein the first driving magnet is magnetized such that a surface of the first driving magnet facing the first driving coil comprises a first polarity region of a first polarity and a second polarity region of a second polarity different from the first polarity.

3. The optical module of claim 2, wherein the first sensing magnet is magnetized such that a surface of the first sensing magnet facing the housing comprises a first polarity region of a first polarity and a second polarity region of a second polarity different from the first polarity.

4. The optical module of claim 3, wherein the first driving magnet comprises two magnets, and
wherein one magnet of the two magnets of the first driving magnet is disposed such that the first polarity region of the one magnet is adjacent to the first sensing magnet, and another magnet of the two magnets of the first driving magnet is disposed such that the second polarity region of the another magnet is adjacent to the first sensing magnet.

5. The optical module of claim 4, wherein the first sensing magnet is disposed such that the first polarity region of the first sensing magnet is adjacent to the magnet of the two magnets in which the first polarity region thereof is adjacent to the first sensing magnet, and the second polarity region of the first sensing magnet is adjacent to the magnet of the two magnets in which the second polarity region thereof is adjacent to the first sensing magnet.

6. The optical module of claim 1, wherein the first position sensor is disposed to face the first sensing magnet.

7. The optical module of claim 6, wherein the first sensing magnet is magnetized such that a surface of the first sensing magnet that faces the first position sensor comprises a first polarity region and a second polarity region,
wherein a neutral region is provided between the first polarity region and the second polarity region, and
wherein the first position sensor is disposed to face the neutral region.

8. The optical module of claim 1, wherein the first position sensor is spaced apart from the first sensing magnet in the direction perpendicular to both the first rotational axis and the second rotational axis.

9. An optical module, comprising:
a housing;
a rotation holder disposed in the housing, and configured to rotate about a first rotational axis;
a reflection holder on which an optical member is mounted, and supported on the rotation holder, and configured to rotate about a second rotational axis perpendicular to the first rotational axis;
a plurality of first driving magnets disposed on the rotation holder; and
a first sensing magnet disposed between the plurality of first driving magnets to have a gap in a second rotational axis direction.

10. The optical module of claim 9, wherein the plurality of first driving magnets and the first sensing magnet are magnetized such that a surface of the plurality of first driving magnets and a surface of the first sensing magnet, facing the housing, comprise a first polarity region of a first polarity and a second polarity region of a second polarity different from the first polarity.

11. The optical module of claim 10, wherein the plurality of first driving magnets and the first sensing magnet are disposed such that same polarity regions of the first driving magnets and the first sensing magnet are adjacent to each other.

12. The optical module of claim 10, further comprising a plurality of first driving coils disposed in the housing to face each of the plurality of first driving magnets.

13. The optical module of claim 10, further comprising a first position sensor disposed in the housing to face the first sensing magnet.

14. The optical module of claim 10, further comprising a first position sensor disposed in the housing to be spaced apart from the first sensing magnet in a direction perpendicular to both the first rotational axis and the second rotational axis.

15. The optical module of claim 10, wherein the plurality of first driving magnets are disposed obliquely each other such that a distance between first end portions of each of the plurality of first driving magnets adjacent to the first sensing magnet are closer to each other than a distance between second end portions of each of the plurality of second driving magnets disposed away from the first sensing magnet.

16. A camera module, comprising:
the optical module according to claim 1; and
a lens module comprising one or more lenses disposed in an optical axis direction and configured to move in the optical axis direction.

17. An optical module, comprising:
a housing;
a rotation holder disposed in the housing, and configured to rotate about a first rotational axis;
a reflection holder on which an optical member is mounted, and supported by the rotation holder, and configured to rotate about a second rotational axis perpendicular to the first rotational axis;
a rotational axis ball disposed between the housing and the rotation holder, and forming the first rotational axis;
a first sensing magnet disposed on the rotation holder in a position spaced apart from the rotational axis ball in a direction perpendicular to both the first rotational axis and the second rotational axis; and
a driving magnet comprising a first driving magnet and a second driving magnet,
wherein the first driving magnet, the second driving magnet, and the first sensing magnet are disposed in sequence along an axis perpendicular to the first rotational axis.
